(19) United States
(12) Patent Application Publication
(10) Pub. No.: US 2007/0146415 A1
(43) Pub. Date: Jun. 28, 2007

(54) Inkjet image forming apparatus having a wiping unit

(75) Inventors: Youn-gun Jung, Gunpo-si (KR); Dong-woo Ha, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/522,953

(22) Filed: Sep. 19, 2006

(30) Foreign Application Priority Data
Dec. 28, 2005 (KR) 2005-131910

(51) Int. Cl. B41J 2/165

(52) U.S. Cl. 347/33

(57) ABSTRACT

An inkjet image forming apparatus includes an inkjet head including a nozzle portion having a length in a main scanning direction that is at least equal to a width of a sheet of paper, a platen to move between a printing position where the platen faces the nozzle portion and supports a rear surface of the paper, and a maintenance position spaced-apart from the printing position in a sub-scanning direction, a wiping unit including a wiper to clean the nozzle portion, and a link arm having a first end portion that is rotatably connected to the wiping unit, and a second end portion that is rotatably connected to the platen. A first angle formed by a first line that connects the wiper to the first end portion and a second line that connects the first end portion and the second end portion when the platen is located at the printing position is smaller than a second angle between the first line and the second line when the platen is located at the maintenance position.

### CROSS-REFERENCE TO RELATED APPLICATIONS

This application claims priority under 35 U.S.C. § 119(a) from Korean Patent Application No. 10-2005-0131910, filed on Dec. 28, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an inkjet image forming apparatus including an inkjet head having a nozzle portion, a length of which in a main scanning direction corresponds to a width of a sheet of paper, and a wiping unit to clean the nozzle portion.

2. Description of the Related Art

In general, an inkjet image forming apparatus forms images by ejecting ink from an inkjet head, which reciprocates in a main scanning direction (shuttle type inkjet head), onto a sheet of paper conveyed in a sub-scanning direction. The inkjet head includes a nozzle portion having a plurality of nozzles through which ink is injected. Ink droplets that are not ejected remain around the nozzle portion. If the nozzle portion is exposed to air when a printing operation is not performed, the ink droplets around the nozzle portion may be hardened, and impurities such as fine dust in the air may get attached onto the nozzle portion. The hardened ink or impurities may change an ink ejection direction, thereby degrading a printing quality. In addition, since ink in the nozzles evaporates, the nozzles may be clogged. Therefore, a maintenance process such as a wiping operation should be performed in order to remove the impurities from the nozzle portion.

Recently, a high speed printing operation is performed using an inkjet head (array inkjet head) including a nozzle portion having a length in a main scanning direction corresponding to a width of a sheet of paper. In the inkjet image forming apparatus, the inkjet head is fixed, and the paper is conveyed in a sub-scanning direction. Therefore, a driving unit for the inkjet image forming apparatus has a simple structure, and the printing operation can be performed at a high speed. In the inkjet image forming apparatus, the length of the nozzle portion corresponding to A4 size paper is about 210 mm without considering a printing margin in a width direction of the paper. Since the array inkjet head ejects ink in a fixed position unlike the shuttle type inkjet head reciprocating in the main scanning direction, it is difficult to fix operational problems when at least a portion of the plurality of nozzles are clogged or the ejecting direction of the ink is changed by impurities. Therefore, an effective wiping operation should be performed.

### SUMMARY OF THE INVENTION

The present general inventive concept provides an inkjet image forming apparatus that can effectively wipe a nozzle portion in an array inkjet head.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an inkjet image forming apparatus including an inkjet head including a nozzle portion having a length in a main scanning direction that is at least equal to a width of a sheet of paper, a platen to move between a printing position where the platen faces the nozzle portion and supports a rear surface of the paper, and a maintenance position spaced apart from the printing position in a sub-scanning direction, a wiping unit including a wiper to clean the nozzle portion, and a link arm having a first end portion that is rotatably connected to the wiping unit, and a second end portion that is rotatably connected to the platen, wherein a first angle formed by a first line that connects the wiper to the first end portion and a second line that connects the first end portion and the second end portion when the platen is located at the printing position is smaller than a second angle between the first line and the second line when the platen is located at the maintenance position.

The inkjet image forming apparatus may further include a plurality of the link arms separated from each other in the main scanning direction and connected to each other using a connection member. The first angle between the first and second lines may be an acute angle when the platen is located at the printing position, and the second angle between the first and second lines may be an obtuse angle when the platen is located at the maintenance position. The platen may be located above the wiping unit at the printing position. The apparatus may further include a wiping trace including a wiping section to guide the wiping unit to clean the nozzle portion during the platen moves from the maintenance position to the printing position, and a returning section to guide the wiping unit not to contact the nozzle portion during the platen moves from the printing position to the maintenance position, and a controlling member to restrict a change of an angle between the first and second lines during the wiping unit is guided by the wiping section. The controlling member may support one of the wiping unit and the link arms when the wiping unit is guided by the wiping section. The connection member may include an eccentric portion that is eccentric with respect to the second end portions of the link arms, and the controlling member supports the eccentric portion.

The inkjet image forming apparatus may further include a wiping trace including a wiping section guiding the wiping unit to clean the nozzle portion when the platen moves from the maintenance position to the printing position, and a returning section to guide the wiping unit not to contact the nozzle portion during the platen moves from the printing position to the maintenance position, a cam follower disposed on the wiping unit and inserted into the wiping trace, and a controlling member to restrict an angle between the first and second lines not to rotate in a direction of reducing the angle about the cam follower when the wiping unit is guided by the wiping section. The controlling member may support one of the wiping unit and the link arms when the wiping unit is guided by the wiping section. The plurality of link arms may be separated from each other in the main scanning direction and are connected to each other using a connection member, the connection member may include an eccentric portion that is eccentric with respect to the second end portions of the link arms, and the controlling member may support the eccentric portion.

The foregoing and/or other aspects of the present general inventive concept may also be achieved by providing an inkjet image forming apparatus including an inkjet head including a nozzle portion having a length in a main scanning direction that is at least equal to a width of a sheet of paper, a platen to move between a printing position where the platen faces the nozzle portion and supports a rear surface of the paper, and a maintenance position spaced apart from the printing position in a sub-scanning direction, a wiping unit including a wiper cleaning the nozzle portion; a link arm having a first end portion that is rotatably connected to the wiping unit, and a second end portion that is rotatably connected to the platen, a wiping trace to guide the wiping unit so that the wiper cleans the nozzle portion during the platen moves, a cam follower disposed on the wiping unit and inserted into the wiping trace, and a controlling member to restrict the wiping unit not to rotate about the cam follower during the wiper cleans the nozzle portion.

The wiping trace may guide the wiping unit to clean the nozzle portion during the platen moves from the maintenance position to the printing position, and may guide the wiping unit not to contact the nozzle portion when the platen moves from the printing position to the maintenance position. A plurality of link arms that are separated from each other in the main scanning direction may be formed, and the plurality of link arms may be connected to each other using a connection member. The connection member may include an eccentric portion that is eccentric with respect to the second end portions of the link arms, and the controlling member may support at least one of the wiping unit, the link arms, and the eccentric portion.

The foregoing and/or other aspects of the present general inventive concept may also be achieved by providing an inkjet image forming apparatus including an inkjet head including a nozzle portion having a length in a main scanning direction that is at least equal to a width of a printing medium, a platen to move between a printing position where the platen faces the nozzle portion and supports a rear surface of the printing medium, and a maintenance position apart from the printing position in a sub-scanning direction, a wiping unit including a wiper to clean the nozzle portion, and a link arm connected between the wiping unit and the platen such that a movement of the wiping unit with respect to the platen is restricted during a predetermined period of time when the platen moves between the printing position and the maintenance position.

The link arm may form an angle with the wiping unit, and the angle may be maintained constant during the predetermined period of time and may vary during a second period of time other than the predetermined period of time when the platen moves between the printing position and the maintenance position.

The platen may be spaced apart from the wiping unit by a distance, and the distance is maintained constant during the predetermined period of time and may vary during a second period of time other than the predetermined period of time when the platen moves between the printing position and the maintenance position.

The inkjet image forming apparatus may further include a controlling member to contact at least one of the wiping unit and the link arm to restrict the movement of the wiping unit with respect to the platen.

The movement of the wiping unit with respect to the platen may not be restricted during a second predetermined period of time other than the predetermined period of time, when the platen moves between the printing position and the maintenance position.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an inkjet image forming apparatus according to an embodiment of the present general inventive concept;

FIG. 2 is a view illustrating a nozzle portion in the inkjet image forming apparatus of FIG. 1;

FIG. 3 is a block diagram illustrating a maintenance device of the image forming apparatus of FIG. 1 according to an embodiment of the present general inventive concept;

FIG. 4 is a detailed exploded perspective view illustrating a platen and a wiping unit in the inkjet image forming apparatus of FIG. 1;

FIG. 5 is a detailed perspective view illustrating the platen and the wiping unit of FIG. 4;

FIG. 6 is an exploded perspective view illustrating the maintenance device of FIG. 3;

FIG. 7 is a detailed view illustrating a guide slot and a wiping trace of the maintenance device of FIG. 6;

FIG. 8 is a side view illustrating a nozzle portion that is capped in the inkjet image forming apparatus of FIG. 1;

FIG. 9A through 9D are views illustrating the platen and the wiping unit moving from a printing position to a maintenance position;

FIGS. 9E, 9G, and 9H are views illustrating the platen and the wiping unit moving from the maintenance position to the printing position;

FIG. 9F is a view illustrating the platen and the wiping unit moving without a control member; and

FIG. 9I is a view illustrating the platen located at the printing position in a case where a link arm is fixedly coupled to a support arm and the platen.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

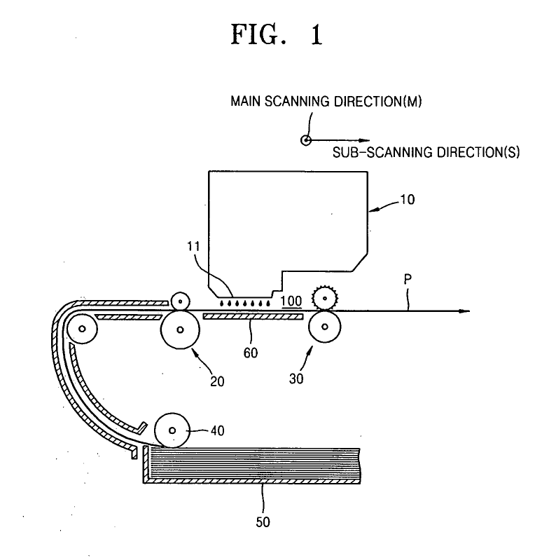

FIG. 1 is a block diagram illustrating an inkjet image forming apparatus according to an embodiment of the present general inventive concept. Referring to FIG. 1, a printing medium, such as a sheet of paper (P), picked from a paper cassette 50 by a pickup roller 40 is conveyed along a paper conveying path 100 in a sub-scanning direction (S) by a conveying unit 20. An inkjet head 10 is installed above the paper (P). The inkjet head 10 ejects ink onto the paper P disposed on a platen 60 at a desired position to print an image on the paper P. The paper P is discharged by a discharging unit 30.

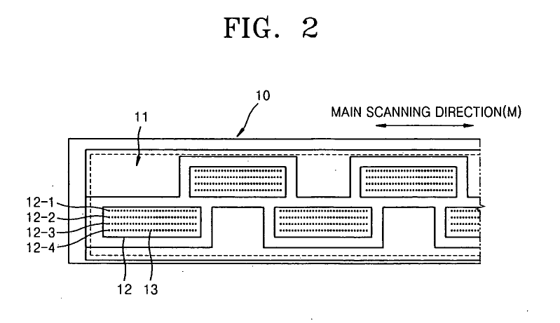

The inkjet head 10 is an array inkjet head. In addition, a length of a nozzle portion 11 in a main scanning direction (M) is at least equal to a width of the paper P. FIG. 2 illustrates an example of the nozzle portion 11 of FIG. 1. Referring to FIG. 2, the nozzle portion 11 includes a plurality of nozzle plates 12 that are arranged in zigzag in the main scanning direction M. Each of the nozzle plates 12 includes a plurality of nozzles 13 to eject ink. The nozzle plate 12 may include a plurality of nozzle rows 12-1, 12-2, 12-3, and 12-4. In addition, the respective nozzle rows 12-1, 12-2, 12-3, and 12-4 may eject ink of the same color or may eject ink of different colors (for example, inks cyan, magenta, yellow, and black). Although FIG. 2 illustrates an example of the nozzle portion 11, the present general inventive concept is not limited thereto. Although it is not illustrated in the drawings, the inkjet head 10 includes a chamber having a discharge unit connected to the nozzle and providing a pressure for discharging ink (for example, a piezoelectric device or a heater), and a flowing path to supply ink to the chamber. The chamber, the discharge unit, and the flowing path are well known to those who skilled in the art, and thus, detailed descriptions thereof are omitted.

Referring back to FIG. 1, the platen 60 faces the nozzle portion 11 and supports a rear surface of the paper P, thereby forming the paper conveying path 100. The platen 60 is positioned so that the nozzle portion 11 of the inkjet head 10 is maintained at a predetermined distance, for example, 0.5-2 mm, from the paper P. The discharge unit 30 discharging the paper P, on which the image is printed, is installed on an outlet side of the inkjet head 10.

If the nozzle portion 11 is exposed to air when a printing operation is not performed, ink droplets around the nozzle portion 11 may be hardened, and impurities such as fine dust in the air can get attached to the nozzle portion 11. The hardened ink or the impurities may change an ink ejection direction, thereby degrading a printing quality. In addition, since humidity of the ink in the nozzles 13 evaporates continuously and a viscosity of the ink in the nozzles 13 increases. Further, the ink in the nozzles 13 may be hardened. Thus, the nozzle portion 11 may be clogged by the ink of high viscosity or the hardened ink. Since the inkjet head 10 prints the image at a fixed position, if at least a portion of the nozzles 13 is clogged with ink, a white line is illustrated in the printed image at a portion corresponding to the nozzle that is clogged.

The nozzle portion 11 should be maintained in an optimal condition to perform the printing operation and obtain high printing quality. To do this, maintenance operations such as a preliminary spitting process, a wiping process, and a capping operation are performed. If the printing operation is not performed for a predetermined time or if the nozzle 13 is not used for a predetermined time during the printing operation, the ink in the nozzle 13 and around the nozzle 13 dries and the viscosity of the ink increases. Thus, a defective ejection operation may occur. The preliminary spitting process is an operation of spitting the ink a few times in a predetermined period of time in order to remove the ink of which viscosity has increased. In the wiping process, a surface of the nozzle portion 11 is wiped in order to remove the hardened ink and impurities around the nozzle 13. The capping process is performed in order to separate the nozzle portion 11 from the outside air and prevent the nozzle 13 from drying by capping the nozzle portion 11 when the printing operation is not performed for a predetermined time.

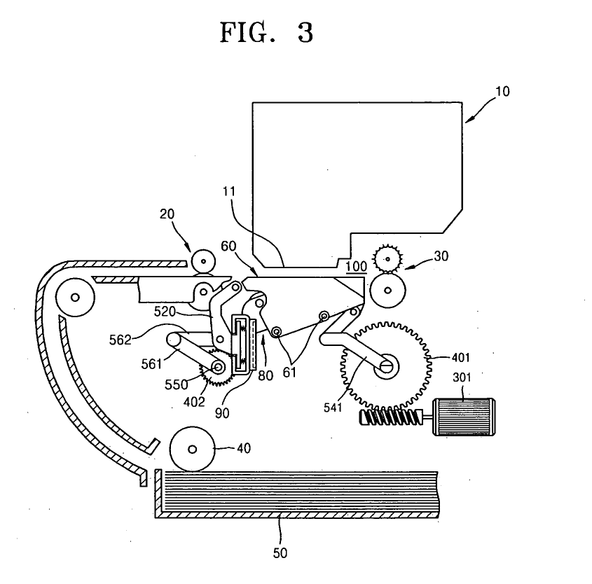

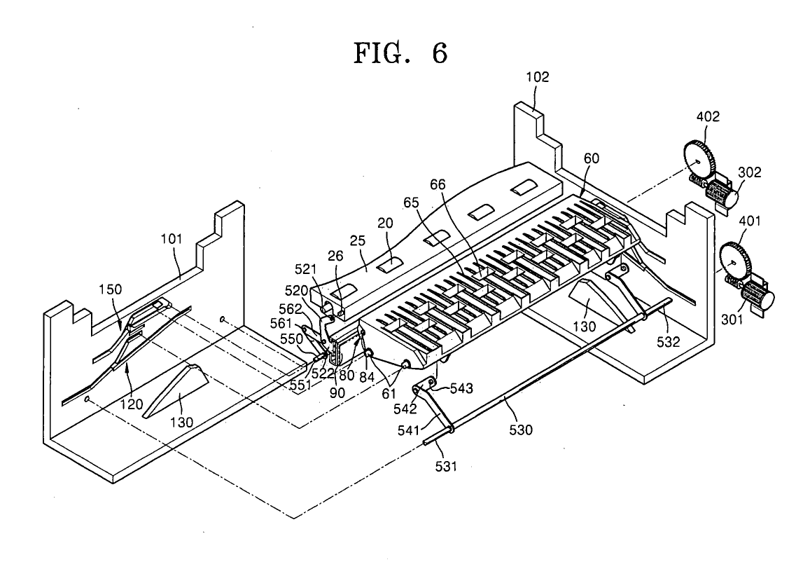

FIG. 3 is a diagram illustrating a maintenance device of the image forming apparatus of FIG. 1 according to an embodiment of the present general inventive concept. In order to maintain the nozzle portion 11 in an optimal state, the inkjet image forming apparatus includes a cap member 90 to cap the nozzle portion 11 to isolate the nozzle portion 11 from the outside air, and a wiping unit 80 to clean the nozzle portion 11 as illustrated in FIG. 3. In the image forming apparatus according to the present embodiment, the platen 60 can move between a printing position in the paper conveying path 100 and a maintenance position separated from the printing position in the sub-scanning direction. The cap member 90 caps/uncaps the nozzle portion 11 when the platen 60 is located at the maintenance position. In addition, in the image forming apparatus of the present embodiment, the wiping unit 80 is connected to the platen 60 so that the wiping unit 80 cleans the nozzle portion when the platen 60 moves, for example, when the platen 60 moves from the maintenance position to the printing position. The platen 60 moves according to a movement of a maintenance motor 301, a gear 401, and a pair of levers 541. The cap member 90 moves according to a movement of a cap member 302 (FIG. 6), a gear 402, a second shaft 550, first and second drive arms 561 and 562, and a cap arm 520 connected to the platen 60.

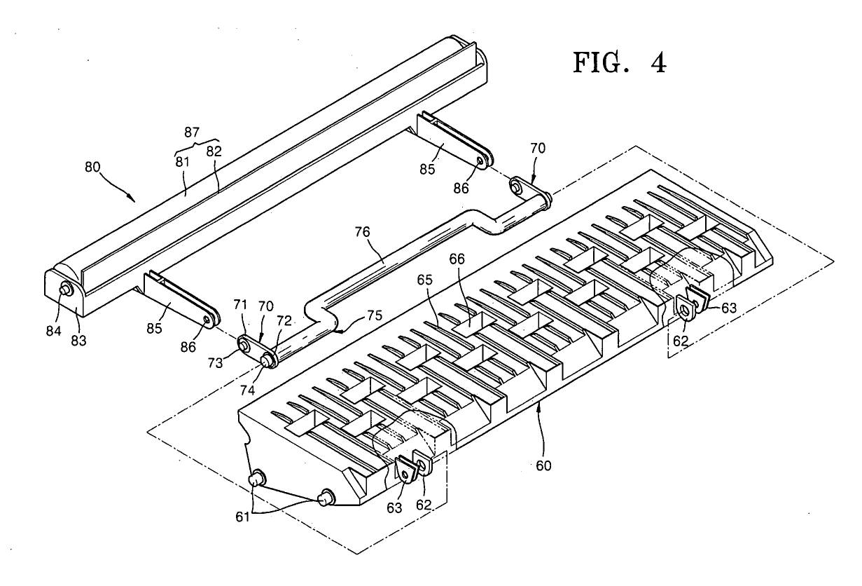

Referring to FIGS. 3, 4, and 5, the platen 60 includes a plurality of ribs 65 supporting the rear surface of the paper P. In addition, the platen 60 includes a plurality of receiving portions 66 corresponding to the plurality of nozzle plates 12 illustrated in FIG. 2 in order to receive the preliminarily spitted ink. The shape of the receiving portions 66 is not limited to the example illustrated in FIG. 4.

A wiper 87 to clean the nozzle portion 11 is installed on a holder 83. The wiping unit 80 includes a wiping roller 81 and/or a wiping blade 82 as the wiper 87, as illustrated in FIG. 4. The wiping roller 81 may be formed of a material that can absorb ink such as a sponge. The wiping blade 82 may be formed of a material having flexibility such as rubber. The holder 83 includes a cam follower 84. In addition, the holder 83 includes a pair of supporting arms 85, and each of the supporting arms 85 includes a first insertion hole 86 at an end portion thereof.

A pair of link arms 70 are rotatably connected to the platen 60 and the wiping unit 80. A first boss 73 and a second boss 74 are formed on a first end portion 71 and a second end portion 72 of the link arm 70, respectively. The platen 60 includes a second insertion hole 62. The first and second bosses 73 and 74 are inserted into the first and second insertion holes 86 and 62, respectively. The pair of link arms 70 can be connected to each other by a connection member 75. The connection member 75 may include an eccentric portion 76 that is eccentric with respect to the second end portions 72 of the link arms 70. Operations of the eccentric portion 76 will be described later.

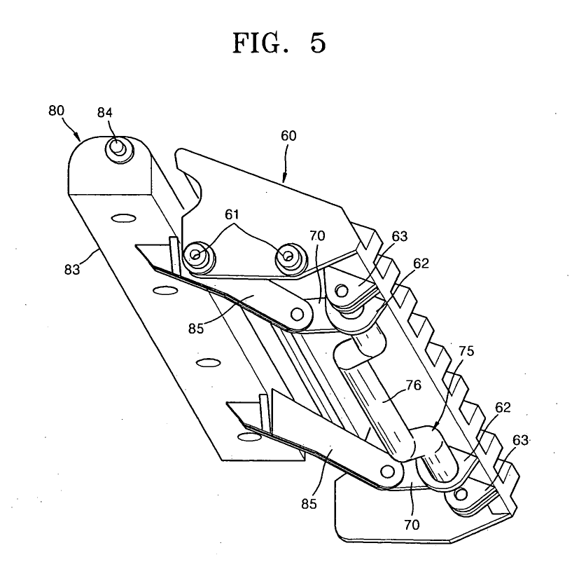

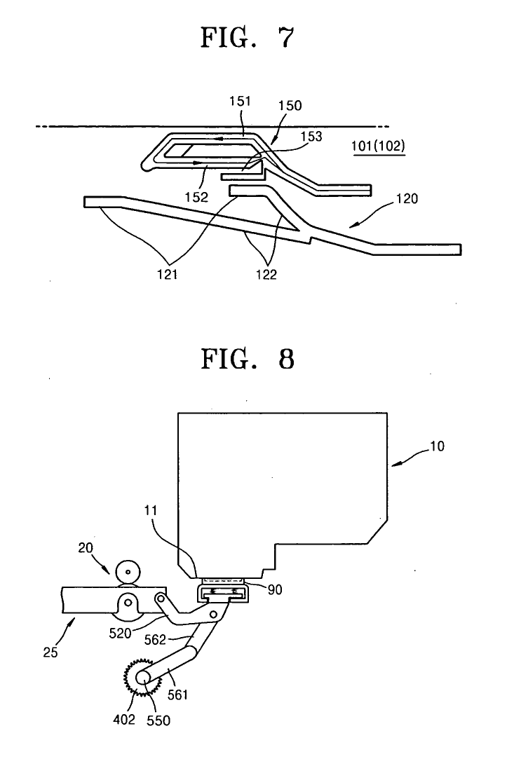

Referring to FIG. 6, the platen 60 is coupled to side walls 101 and 102. The side walls 101 and 102 respectively include guide slots 120 illustrated in FIG. 7. Protrusions (61 of FIG. 4) are formed on both sides of the platen 60. The protrusions 61 are inserted into the guide slots 120. The platen 60 moves to the printing position or the maintenance position along the guide slots 120. Each of the guide slots 120 includes parallel sections 121 disposed parallel to the paper conveying path 100, and a slant section 122 inclined downward from the parallel section 121. The slant section 122 guides the platen 60 under the discharge unit 30 so that the platen 60 and the discharge unit 30 do not interfere with each other when the platen 60 moves to the maintenance position. A first shaft 530 is rotatably supported by the side walls 101 and 102. D-cut portions 531 and 532 are formed on both ends of the first shaft 530. The pair of first levers 541 are coupled to the respective D-cut portions 531 and 532 of the first shaft 530 such that the first levers 511 rotate together with the first shaft 530, and are respectively connected to a pair of second levers 542 to be rotatable. Third bosses 543 are disposed on end portions of the second levers 542. The third bosses 543 are respectively inserted into third insertion holes 63 (refer to FIGS. 4 and 5) formed in the platen 60. The gear 401 is coupled to the D-cut portion 532 such that the first shaft 530 rotates together with the gear 401. The maintenance motor 301 rotates the gear 401 to move the platen 60 to the printing position and to the maintenance position.

Referring to FIG. 6, a wiping trace 150 is formed on the side walls 101 and 102. The cam follower 84 of the wiping unit 80 is coupled to the wiping trace 150. Referring to FIG. 7, the wiping trace 150 includes a wiping section 151 that guides the wiping unit 80 such that the wiper 87 can contact the nozzle portion 11 when the platen 60 moves from the maintenance position to the printing position. The guide section 151 guides the cam follower 84 in an arrow line direction. The wiping trace 150 further includes a returning section 152 that guides the wiping unit 80 such that the wiper 87 does not contact the nozzle portion 11 when the platen 60 moves from the printing position to the maintenance position. The returning section 152 guides the cam follower 84 in a second arrow line direction. An elastic arm 153 performs as a latch that blocks the cam follower 84 from entering into the returning section 152 when the platen 60 moves from the maintenance position to the printing position. The elastic arm 153 allows the cam follower 84 to enter the wiping section 151 after passing through the returning section 152 when the platen 60 moves from the printing position to the maintenance position.

Referring to FIGS. 3 and 6, the cap arm 520 is rotatably installed on a guide member 25 that guides the paper under the nozzle portion 11. An end of the cap arm 520 is coupled to a rotary shaft 26 formed on the guide member 25. The cap member 90 is installed on the other end 522 of the cap arm 520. The second shaft 550 is rotatably supported by the side walls 101 and 102. D-cut portions 551 are formed in both ends of the second shaft 550. A pair of first cap driving arms 561 are coupled to the D-cut portions 551 of the second shaft 550. In addition, the pair of the first cap driving arms 561 are rotatably connected to a pair of second cap driving arms 562 that are rotatably connected to the cap arm 520. The gear 402 is coupled to the D-cut portion 551 of the second shaft 550. The cap motor 302 rotates the gear 402 to move the cap member 90 to a capping position (refer to FIG. 8) and to an uncapping position (refer to FIG. 3).

Hereinafter, maintenance operations using the above structure will be described as follows.

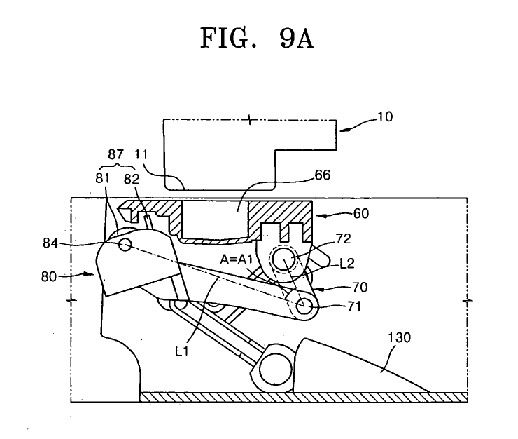

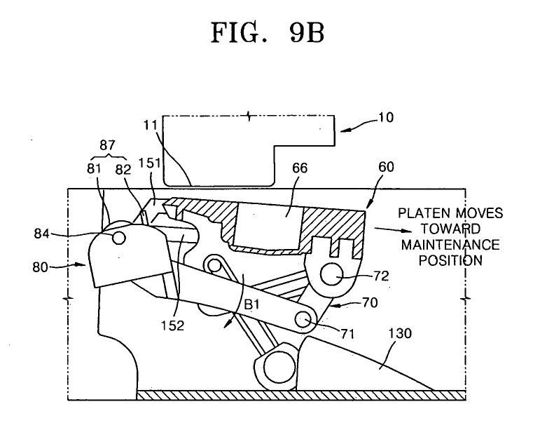

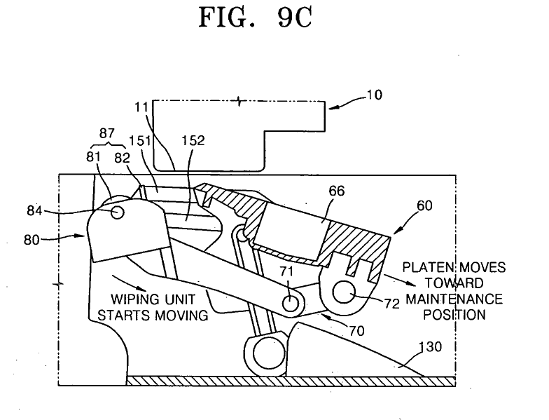

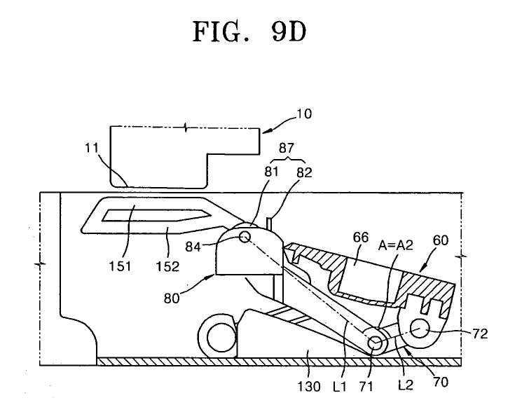

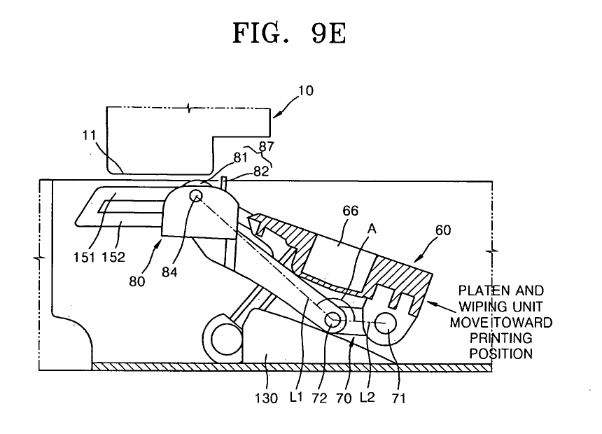

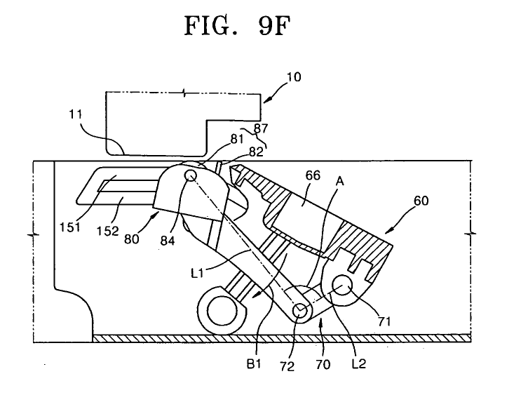

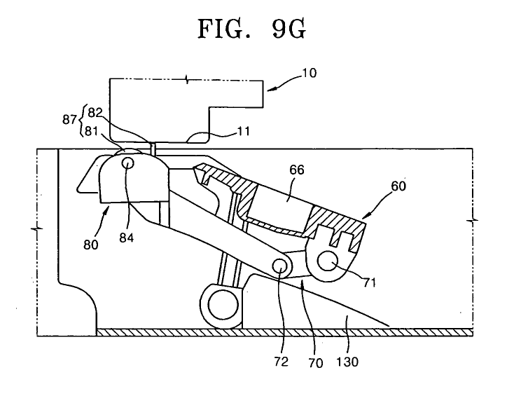

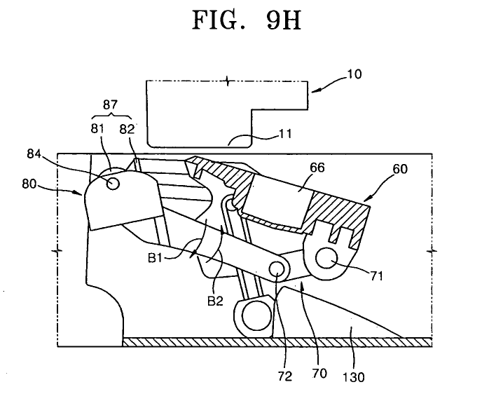

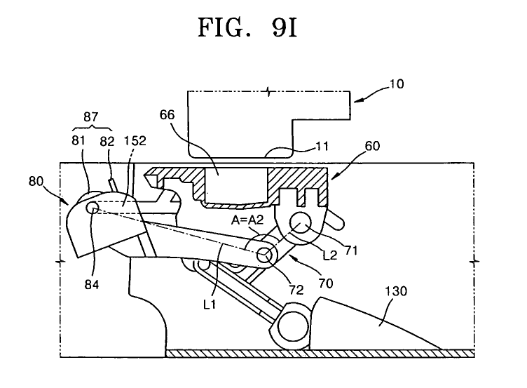

Referring to FIGS. 3 and 9A, the platen 60 is located at the printing position and supports the rear surface of the paper P. The cap member 90 is located at the uncapping position. The protrusion 61 of the platen 60 is supported by the parallel sections 121 of the guide slot 120. Therefore, even if the platen 60 is not accurately positioned at the printing position, a distance between the nozzle portion 11 and the upper surface of the paper P can be maintained accurately as long as the protrusion 61 is supported by the parallel section 121. The wiping unit 80 is disposed under the platen 60. When the cam follower 84 of the wiping unit 80 is guided from the wiping section 151 to be located at the returning section 152, and the wiper 87 is separated from the nozzle portion 11. The paper P is picked from the paper cassette 50 using the pickup roller 40. The conveying unit 20 conveys the paper P along the paper conveying path 100. The inkjet head 10 ejects ink onto the paper P to print an image. The discharge unit 30 discharges the paper P, on which the image is printed. Before printing the image or after performing a printing operation onto a few sheets of paper P, the preliminary spitting operation is performed when no paper P exists along the paper conveying path 100. The preliminarily spitted ink drops onto the plurality of receiving portions 66 (FIG. 6) formed on the platen 60. Therefore, even if the paper P is conveyed after performing the preliminary spitting operation, the rear surface of the paper P is not contaminated by the ink that is received in the receiving portions 66.

When the maintenance motor 301 rotates the gear 401, the first shaft 530 and the first and second levers 541 and 542 connected to the first shaft 530 are rotated. The second lever 542 pulls the platen 60 in the sub-scanning direction S. The protrusions 61 of the platen 60 are guided by the slant section 122 when they are out of the parallel sections 121. When the platen 60 starts to move to the maintenance position, the cam follower 84 of the wiping unit 80 is located at the returning section 152 and may start to move in the second arrow line direction in the returning section 152 a predetermined period of time after the platen 60 starts to move to the maintenance position.

Even if the platen 60 moves, the wiping unit 80 does not move. Instead of moving, the wiping unit 80 is rotated in a directed denoted by an arrow B1 in FIG. 9B according to a movement of the cam follower 84. When the link arm 70 rotates, an angle (A) formed by a first line (L1) connecting the wiper 87 and the first end portion 71 of the link arm 70 and a second line (L2) connecting the first and second end portions 71 and 72 of the link arm 70 gradually increases. Therefore, since the wiping unit 80 includes the wiping roller 81 and the wiping blade 82 as the wiper 87, the first line (L1) connects a center of the wiping roller 81 and the first end portion 71 of the link arm 70. According to the present embodiment, when the center of the wiping roller 81 is identical to that of the cam follower 84, the first line L1 connects the cam follower 84 and the first end portion 71. The wiping roller 81 and the wiping blade 82 are adjacent to each other, and thus, the first line L1 may be a line connecting the wiping blade 82 and the first end portion 71 of the link arm 70. In the printing position, a distance between the wiper 87 and the second end portion 72 (second insertion hole 62 of the platen 60) is shorter than a sum of the first line and the second line.

Referring to FIG. 9C, when the platen 60 moves to the maintenance position by a predetermined distance or degree, the link arm 70 starts to pull the wiping unit 80, and then, the wiping unit 80 moves together with the platen 60. The wiping unit 80 is guided by the returning section 152. The cam follower 84 passes through the elastic arm 153, and enters an extended portion of the wiping section 151 such that the platen 60 and the wiping unit 80 reach the maintenance position as illustrated in FIG. 9D. When the distance is longer than a predetermined distance or an angle between the first line and the second line is greater than a predetermined degree, the wiping unit 80 starts to move along the returning section 152 to the extended portion of the wiping section 151 according to the movement of the platen 60.

In the above status, if a printing command is not input, the cap motor 302 drives to move the cap member 90 to the capping position as illustrated in FIG. 8 and to cap the nozzle portion 11, and waits until the printing command is input.

When the printing command is input, the cap motor 302 rotates to move the cap member 90 to the uncapping position as illustrated in FIG. 3. Then, the maintenance motor 301 rotates the gear 401 to move the platen 60 to the printing position. The platen 60 and the wiping unit 80 start to move to the printing position from the maintenance position, for example, a position illustrated in FIG. 9D. The elastic arm 153 blocks the cam follower 84 not to enter the returning section 152. Therefore, the wiping unit 80 is guided by the wiping section 151.

Referring to FIG. 9E, when the wiper 87 contacts the nozzle portion 11, the wiping unit 80 tends to rotate in a direction denoted by an arrow B1 (FIG. 9F), that is, in a direction of reducing the angle A between the first and second lines L1 and L2 about the cam follower 84. When the wiping unit 80 rotates in the direction B1 about the cam follower 84, the wiping unit 80 does not move in a wiping direction to wipe the nozzle unit 11 even when the platen 60 moves to the printing position, as illustrated in FIG. 9F. Then, a front edge of the platen 60 and the wiping unit 80 may interfere with each other. In addition, when the angle A between the first and second lines L1 and L2 is reduced, the wiping unit 80 may be inserted between the link arm 70 and the nozzle portion 11 as a wedge so that the platen 60 and the wiping unit 80 cannot move. Therefore, the image forming apparatus according to the present embodiment includes a controlling member 130 to support the link arm 70 or the wiping unit 80 (preferably, the supporting arm 85) so that the wiping unit 80 does not rotate in the direction B1.

The controlling member 130 supports the link arm 70 or the wiping unit 80 (or the supporting arm 85) so that the angle A is not changed to a predetermined angle but maintained at another predetermined angle when the wiping unit 80 is guided by the wiping section 151, for example, so that the angle A can be maintained constantly until the wiping operation is finished, as illustrated in FIG. 9G. Therefore, when the wiping unit 80 is guided by the wiping section 151, a contacting pressure of the wiper 87 onto the nozzle portion 11 can be maintained constantly. In addition, the connection member 75 (FIG. 4) connecting the pair of link arms 70 is formed to maintain the contacting pressure of the wiper 87 onto the nozzle portion 11 in the main scanning direction M. Although it is not illustrated in the drawings, the controlling member 130 can support the eccentric portion 76 of the connection member 75 so that the wiping unit 80 does not rotate in the direction B1 when the wiping unit 80 is guided by the wiping section 151. When the wiping unit 80 is guided by the wiping section 151, the link arm 70 pushes the wiping unit 80, and thus, the angle A between the first and second lines L1 and L2 may become obtuse.

Referring to FIG. 9H, when the wiping operation is finished and the cam follower 84 enters the returning section 152 after escaping from the wiping section 151, the wiper 87 is separated from the nozzle portion 11. The platen 60 does not reach the printing position yet. The link arm 80, the wiping unit 80 (or the supporting arm 85), the eccentric portion 76 of the connection member 75 are separated from the controlling member 130. Therefore, the wiping unit 80 can rotate in the direction B1 about the cam follower 84. When the platen 60 moves toward the printing position, the wiping unit 80 (supporting arm 85) slightly rotates in the direction B1 about the cam follower 84, and then rotates in the direction B2 again. While the angle A between the first and second lines L1 and L2 gradually reduces, the wiping unit 80 does not move and the platen 60 only moves to reach the printing position.

Referring to FIGS. 9A and 9D, the angle (A=A1) when the platen 60 is located at the printing position is smaller than the angle (A=A2) when the platen 60 is located at the maintenance position. If the link arm 70 is fixedly connected to at least one of the supporting arm 85 and the platen 60, the angle A1 when the platen 60 is located at the printing position may be the same as the angle A2 when the platen 60 is located at the maintenance position. In this case, as illustrated in FIG. 9I, the wiping unit 80 should farther move in the direction of moving the platen 60 when the platen 60 is located at the printing position, and accordingly, the returning section 152 of the wiping trace 150 should be extended as an extended portion as denoted by a dotted line in FIG. 9I.

In addition, the conveying unit 20 should be located far from the nozzle portion 11 so as not to interfere with the wiping unit 80, it is difficult to convey the paper P stably, and a size of the image forming apparatus may be increased. Thus, according to the image forming apparatus of the present embodiment, the platen 60 and the wiping unit 80 are connected to each other using the link arm 70, and the angle A1 when the platen 60 is located at the printing position is formed to be smaller than the angle A2 when the platen 60 is located at the maintenance position (the angle A1 may be acute, and the angle A2 may be obtuse), and thus, a moving distance of the wiping unit 80 can be reduced.

Moreover, when the platen 60 is located at the printing position, the platen 60 can be positioned above the wiping unit 80. Therefore, the conveying unit 20 can be located adjacent to the nozzle portion 11, and the size of the image forming apparatus can be reduced. Furthermore, the pair of link arms 70 are connected to each other using the connection member 75, and thus, the contacting pressure of the wiper 87 onto the nozzle portion 11 can be maintained constantly in the main scanning direction M. Also, a rotation of the wiping unit 80 can be prevented by the controlling member 130, and thus, the contacting pressure of the wiper 87 onto the nozzle portion 11 while the wiping unit 80 is guided by the wiping section 151 is maintained. In addition, the front edge of the platen 60 and the wiping unit 80 do not interfere with each other. On the other hand, the wiping unit 80 is not inserted between the link arm 70 and the nozzle portion 11 as a wedge. Therefore, the entire nozzle portion 11 can be wiped constantly, and the operational reliability of the wiping unit 80 can be ensured.

According to the inkjet image forming apparatus according to the present general inventive concept, the entire nozzle portion of the inkjet head can be wiped constantly. In addition, the image forming apparatus can be manufactured in a smaller size.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image forming apparatus comprising:
an inkjet head including a nozzle portion having a length in a main scanning direction that is at least equal to a width of a printing medium;
a platen to move between a printing position where the platen faces the nozzle portion and supports a rear surface of the printing medium, and a maintenance position apart from the printing position in a sub-scanning direction;
a wiping unit including a wiper to clean the nozzle portion; and
a link arm having a first end portion that is rotatably connected to the wiping unit, and a second end portion that is rotatably connected to the platen,
wherein a first angle formed by a first line that connects the wiper to the first end portion and a second line that connects the first end portion and the second end portion when the platen is located at the printing position is smaller than a second angle between the first line and the second line when the platen is located at the maintenance position.

2. The apparatus of claim 1, further comprising:
a plurality of the link arms separated from each other in the main scanning direction and connected to each other using a connection member.

3. The apparatus of claim 2, wherein the first angle between the first and second lines is an acute angle when the platen is located at the printing position, and the second angle between the first and second lines is an obtuse angle when the platen is located at the maintenance position.

4. The apparatus of claim 3, wherein the platen is located above the wiping unit at the printing position.

5. The apparatus of claim 4, further comprising:
a wiping trace including a wiping section to guide the wiping unit to clean the nozzle portion during the platen moves from the maintenance position to the printing position, and a returning section to guide the wiping unit not to contact the nozzle portion during the platen moves from the printing position to the maintenance position; and
a controlling member to restrict a change of an angle between the first and second lines during the wiping unit is guided by the wiping section.

6. The apparatus of claim 5, wherein the controlling member supports one of the wiping unit and the link arms when the wiping unit is guided by the wiping section.

7. The apparatus of claim 5, wherein the connection member comprises an eccentric portion that is eccentric with respect to the second end portion of the link arm, and the controlling member supports the eccentric portion.

8. The apparatus of claim 1, further comprising:
a wiping trace including a wiping section to guide the wiping unit to clean the nozzle portion when the platen moves from the maintenance position to the printing position, and a returning section to guide the wiping unit not to contact the nozzle portion during the platen moves from the printing position to the maintenance position;
a cam follower disposed on the wiping unit and inserted into the wiping trace; and
a controlling member to restrict an angle between the first and second lines not to rotate in a direction of reducing the angle about the cam follower when the wiping unit is guided by the wiping section.

9. The apparatus of claim 8, wherein the controlling member supports one of the wiping unit and the link arms when the wiping unit is guided by the wiping section.

10. The apparatus of claim 8, wherein:
the plurality of link arms are separated from each other in the main scanning direction and are connected to each other using a connection member:
the connection member comprises an eccentric portion that is eccentric with respect to the second end portions of the link arms; and
the controlling member supports the eccentric portion.

11. An inkjet image forming apparatus comprising:
an inkjet head including a nozzle portion having a length in a main scanning direction that is at least equal to a width of a printing medium;
a platen to move between a printing position where the platen faces the nozzle portion and supports a rear surface of the printing medium, and a maintenance position apart from the printing position in a sub-scanning direction;
a wiping unit including a wiper cleaning the nozzle portion;
a link arm having a first end portion that is rotatably connected to the wiping unit, and a second end portion that is rotatably connected to the platen;
a wiping trace to guide the wiping unit so that the wiper cleans the nozzle portion during the platen moves;
a cam follower disposed on the wiping unit and inserted into the wiping trace; and
a controlling member to restrict the wiping unit not to rotate about the cam follower during the wiper cleans the nozzle portion.

12. The apparatus of claim 11, wherein the wiping trace guides the wiping unit to clean the nozzle portion during the platen moves from the maintenance position to the printing position, and guides the wiping unit not to contact the nozzle portion when the platen moves from the printing position to the maintenance position.

13. The apparatus of claim 12, wherein the link arm comprises a plurality of link arms that are separated from each other in the main scanning direction, and the plurality of link arms are connected to each other using a connection member.

14. The apparatus of claim 13, wherein the connection member comprises an eccentric portion that is eccentric with respect to the second end portions of the link arms, and the controlling member supports at least one of the wiping unit, the link arms, and the eccentric portion.

15. An inkjet image forming apparatus comprising:
an inkjet head including a nozzle portion having a length in a main scanning direction that is at least equal to a width of a printing medium;
a platen to move between a printing position where the platen faces the nozzle portion and supports a rear surface of the printing medium, and a maintenance position apart from the printing position in a sub-scanning direction;
a wiping unit including a wiper to clean the nozzle portion; and
a link arm connected between the wiping unit and the platen such that a movement of the wiping unit with respect to the platen is restricted during a predetermined period of time when the platen moves between the printing position and the maintenance position.

16. The apparatus of claim 15, wherein the wiping unit contacts and wipes the nozzle portion of the inkjet head during the predetermined period of time.

17. The apparatus of claim 16, wherein the link arm forms an angle with the wiping unit, and the angle is maintained constant during the predetermined period of time.

18. The apparatus of claim 16, further comprising:
a controlling member to contact at least one of the wiping unit and the link arm to restrict the movement of the wiping unit with respect to the platen.

19. The apparatus of claim 18, wherein the link arm is rotatably coupled between the wiping unit and the platen.
